(19) United States
(12) Patent Application Publication
(10) Pub. No.: US 2024/0276558 A1
(43) Pub. Date: Aug. 15, 2024

(54) COMMUNICATION APPARATUS, BASE STATION, AND COMMUNICATION METHOD

(71) Applicants: DENSO CORPORATION, Kariya-City (JP); TOYOTA JIDOSHA KABUSHIKI KAISHA, Toyota-shi (JP)

(72) Inventors: Haruhiko SOGABE, Kariya-City (JP); Daiki MAEMOTO, Kariya-City (JP); Tatsuki NAGANO, Kariya-City (JP); Hideaki TAKAHASHI, Kariya-City (JP)

(21) Appl. No.: 18/627,838

(22) Filed: Apr. 5, 2024

Related U.S. Application Data
(63) Continuation of application No. PCT/JP2022/037671, filed on Oct. 7, 2022.

(30) Foreign Application Priority Data
Oct. 8, 2021 (JP) 2021-166340

(51) Int. Cl. H04W 74/0836; H04W 72/02; H04W 72/1268; H04W 74/08

(52) U.S. Cl. CPC H04W 74/0836; H04W 72/02; H04W 72/1268; H04W 74/0866

(57) ABSTRACT

A communication apparatus having at least one of a plurality of features defined in a mobile communication system, the communication apparatus comprising: a receiver configured to receive, from a base station, a system information block including information indicating a plurality of resources of random access and information indicating correspondence between each of the plurality of resources of the random access and a combination of one or more features; and a controller configured to select, from the plurality of resources of the random access, a resource of the random access corresponding to the at least one of the plurality of features which the communication apparatus has, on a basis of the information indicating the correspondence, and to calculate a random access-radio network temporary identifier (RA-RNTI) used in a random access procedure on a basis of the selected resource of the random access. The one or more features includes at least one of a reduced capability (RedCap) feature, a small data feature, a network slicing feature, and a feature for repetition of a message3 (MSG3).

### CROSS-REFERENCE TO RELATED APPLICATIONS

The present application is a continuation application of international Patent Application No. PCT/JP2022/037671, filed on Oct. 7, 2022, which designated the U.S., and claims the benefit of priority of Japanese Patent Application No. 2021-166340, filed on Oct. 8, 2021, the entire contents of which are incorporated herein by reference.

### TECHNICAL FIELD

The present disclosure relates to a communication apparatus, a base station, and a communication method.

### BACKGROUND ART

In the mobile communication system conforming to the technical specification of 3GPP (registered trademark, the same applies hereinafter) (3rd Generation Partnership Project), which is a standardization project of a mobile communication system, as the random access procedure (hereinafter referred to as an RA procedure.), a 4-step random access type RA procedure (hereinafter referred to as a 4-step RA procedure.) and a 2-step random access type RA procedure (hereinafter referred to as a 2-step RA procedure) are supported (see Non Patent Literature 1).

In the random access procedure, the communication apparatus transmits a random access preamble (hereinafter referred to as an RA preamble) to a base station on a physical random access channel (PRACH) occasion. The communication apparatus calculates a radio network temporary identifier (RA-RNTI) for identifying a response (hereinafter referred to as an RA response) with respect to the RA preamble from the PRACH time-frequency index associated with the PRACH occasion (specifically, the time (symbol and slot), the frequency, and the uplink carrier).

Here, in order to avoid an overlapping problem of RNTI in which the RA-RNTI in the 4-step RA procedure and the RA-RNTI (i.e., MSGB-RNTI) in the 2-step RA procedure are the same, the value range (hereinafter referred to as a 2-step value range) that can be taken by the RA-RNTI in the 2-step RA procedure is set so as not to overlap with the value range (hereinafter referred to as a 4-step value range) that can be taken by the RA-RNTI in the 4-step RA procedure. The communication apparatus that has transmitted the RA preamble in the 2-step RA procedure calculates its own RA-RNTI by adding an offset value to a calculation value based on the PRACH time-frequency index so that the calculated RA-RNTI falls within the range of the 2-step value range. As a result, since the RA-RNTI in the 4-step RA procedure and the RA-RNTI (MSGB-RNTI) in the 2-step RA procedure have different values, the communication apparatus can identify the RA response addressed to itself. At present, the 4-step value range is 1 to 17920. Therefore, the 2-step value range is set from 17921 to 35840, and the offset value is 17920 (=14×80×8×2).

In recent years, there has been discussed a technique (so-called RACH partitioning) for notifying, so that the feature the communication apparatus requests to use (hereinafter referred to as request feature) among a plurality of features defined in a mobile communication system can be identified at an early stage to a network side, a request feature of the communication apparatus in an RA procedure. The plurality of features are, for example, a feature in which the capability of the communication apparatus is reduced (RedCap: Reduced Capability), a coverage enhancement feature (Coverage Enhancement), and the like.

### CITATION LIST

### Non Patent Literature

Non Patent Literature 1: 3GPP technical specification: TS38.300 V16.6.0

### SUMMARY OF INVENTION

A communication apparatus according to a first aspect is a communication apparatus having at least one of a plurality of features defined in a mobile communication system. The communication apparatus comprises: a communicator; and a controller. The communicator is configured to receive, from a base station, a message indicating correspondence between a combination of one or a plurality of features and a plurality of PRACH time-frequency index sets different for each combination. The controller is configured to: select, based on the correspondence, a PRACH time-frequency index set corresponding to a request feature in which the communication apparatus requests for use from the plurality of PRACH time-frequency index sets; and calculate a designated identifier from the selected PRACH time-frequency index set according to a designated calculation formula, the designated identifier being a radio network temporary identifier for identifying a random access response from the base station.

A base station according to a second aspect is a base station configured to perform radio communication with a communication apparatus having at least one of a plurality of features defined in a mobile communication system. The base station comprises: a controller configured to generate a message indicating correspondence between a combination of one or a plurality of features and a plurality of PRACH time-frequency index sets different for each combination; and a communicator configured to transmit the message to the communication apparatus.

A communication method according to a third aspect is a communication method executed by a communication apparatus having at least one of a plurality of features defined in a mobile communication system. The communication method comprises the steps of: receiving, from a base station, a message indicating correspondence between a combination of one or a plurality of features and a plurality of PRACH time-frequency index sets different for each combination; selecting, based on the correspondence, a PRACH time-frequency index set corresponding to a request feature in which the communication apparatus requests for use from the plurality of PRACH time-frequency index sets; and calculating a designated identifier from the selected PRACH time-frequency index set according to a designated calculation formula, the designated identifier being a radio network temporary identifier for identifying a random access response from the base station.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration of a mobile communication system according to an embodiment.

FIG. 2 is a diagram illustrating a configuration example of a protocol stack in the mobile communication system according to the embodiment.

FIG. 3 is a diagram illustrating an operation example in a 4-step random access type CBRA.

FIG. 4 is a diagram for explaining a value range of RA-RNTI.

FIG. 5 is a diagram illustrating an operation example in a 2-step random access type CFRA.

FIG. 6 is a diagram illustrating a configuration of a UE according to an embodiment.

FIG. 7 is a diagram illustrating a configuration of a base station according to the embodiment.

FIG. 8 is a sequence diagram for explaining first to eighth operation examples according to one embodiment.

FIG. 9 is an explanatory diagram for explaining the first operation example according to one embodiment.

FIG. 10 is a diagram for describing a value range of an RA-RNTI according to the first to fourth operation examples of one embodiment.

FIG. 11 is an explanatory diagram for explaining the second operation example according to one embodiment.

FIG. 12 is a sequence diagram for explaining the third operation example according to one embodiment.

FIG. 13 is a sequence diagram for explaining the fourth operation example according to one embodiment.

FIG. 14 is a diagram for describing a value range of an RA-RNTI according to fifth to eighth operation examples of one embodiment.

FIG. 15 is a sequence diagram for explaining the fifth operation example according to one embodiment.

FIG. 16 is an explanatory diagram for explaining the sixth operation example according to one embodiment.

FIG. 17 is an explanatory diagram for explaining the seventh operation example according to one embodiment.

FIG. 18 is an explanatory diagram for explaining the eighth operation example according to one embodiment.

FIG. 19 is a sequence diagram for explaining ninth to tenth operation examples according to one embodiment.

FIG. 20 is a diagram for describing a value range of an RA-RNTI according to the ninth to tenth operation examples of one embodiment.

### DESCRIPTION OF EMBODIMENTS

A mobile communication system according to an embodiment will be described with reference to the drawings. In the description of the drawings, the same or similar parts are denoted by the same or similar reference numerals.

In a case where a technique for notifying a request feature of a communication apparatus in the RA procedure is introduced, it is conceivable to differ a value range of the RA-RNTI in each of a plurality of features by increasing an offset value used for calculation of the RA-RNTI according to a type of request feature that can be notified in order to avoid the overlapping problem of the RNTI.

However, the upper limit number that can be allocated as the RNTI is defined in the technical specification of 3GPP. For this reason, if the offset value is continuously increased according to the type of request feature that can be notified, the number of RA-RNTIs exceeds the upper limit number that can be allocated as the RNTI, and there is a concern that shortage (exhaustion) of the allocatable RNTI occurs. Therefore, it is required to calculate an appropriate RA-RNTI by a mechanism different from an existing RA-RNTI calculation method such as a 2-step RA procedure. Therefore, an object of the present invention is to provide a communication apparatus, a base station, and a communication method capable of calculating an appropriate radio network temporary identifier that enables a random access response to be identified when notifying a network of a request feature of the communication apparatus in a random access procedure.

### (System Configuration)

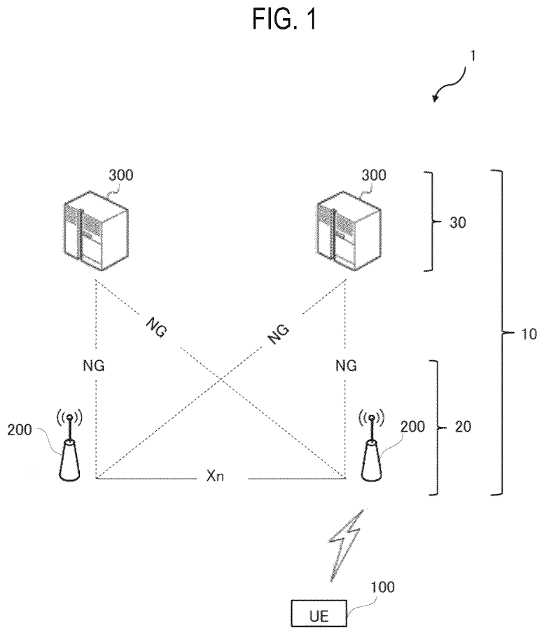

First, a configuration of a mobile communication system 1 according to the present embodiment will be described with reference to FIG. 1. The mobile communication system 1 is, for example, a system conforming to a technical specification (TS) of 3GPP. Hereinafter, as the mobile communication system 1, a description will be given, as an example, as to a 5th generation system (5GS) of the 3GPP standard, that is, a mobile communication system based on NR (New Radio).

The mobile communication system 1 includes a network 10 and a user equipment (UE) 100 that communicates with the network 10. The network 10 includes a NG-RAN (Next Generation Radio Access Network) 20, which is a 5G radio access network, and a 5GC (5G Core Network) 30, which is a 5G core network.

The UE 100 is an example of a communication apparatus. The UE 100 may be a mobile radio communication apparatus. The UE 100 may be an apparatus used by a user. The UE 100 may be a user equipment defined in a technical specification of 3GPP. The UE 100 is, for example, a mobile apparatus such as a mobile phone terminal such as a smartphone, a tablet terminal, a notebook PC, a communication module, or a communication card. The UE 100 may be a vehicle (e.g., a car or a train) or an apparatus provided in the vehicle. The UE 100 may be a transport body other than a vehicle (e.g., a ship or an airplane) or an apparatus provided in the transport body. The UE 100 may be a sensor or an apparatus provided in the sensor. It is noted that the UE 100 may be referred to as another name such as a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit.

The NG-RAN 20 includes a plurality of base stations 200. Each of the base stations 200 manages at least one cell. A cell forms a minimum unit of a communication area. One cell belongs to one frequency (a carrier frequency) and is formed by one component carrier. The term “cell” may represent a radio communication resource, and may also represent a communication object of the UE 100. Each base station 200 can perform radio communication with the UE 100 existing in its own cell. The base station 200 communicates with the UE 100 by using a protocol stack of the RAN. The base station 200 provides NR user plane and control plane protocol terminations towards the UE 100 and is connected to the 5GC 30 via an NG interface. Such an NR base station 200 may be referred to as a gNodeB (gNB). The 5GC 30 includes a core network apparatus 300. The core network apparatus 300 includes, for example, an AMF (Access and Mobility Management Function) and/or a UPF (User Plane Function). The AMF performs mobility management of the UE 100. The UPF provides a feature specialized for user plane processing. The AMF and the UPF are connected to the base station 200 via the NG interface.

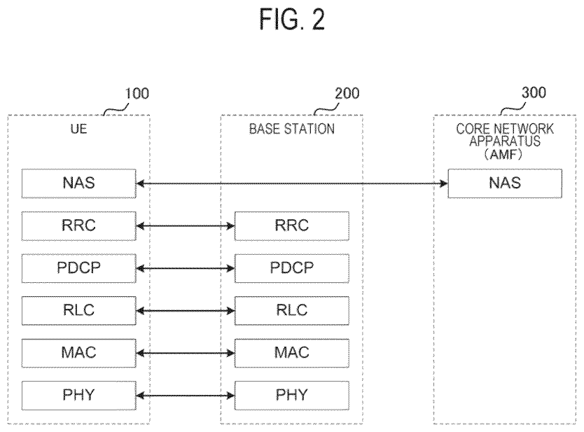

Next, a configuration example of the protocol stack according to the present embodiment will be described with reference to FIG. 2.

A protocol of a radio section between the UE 100 and the base station 200 includes a physical (PHY) layer, a MAC (Medium Access Control) layer, an RLC (Radio Link Control) layer, a PDCP (Packet Data Convergence Protocol) layer, and an RRC (Radio Resource Control) layer.

The PHY layer performs coding/decoding, modulation/demodulation, antenna mapping/demapping, and resource mapping/demapping. Data and control information are transmitted between the PHY layer of the UE 100 and the PHY layer of the base station 200 via a physical channel.

The physical channel includes a plurality of OFDM (Orthogonal Frequency Division Multiplexing) symbols in the time domain and a plurality of subcarriers in the frequency domain. One subframe includes a plurality of OFDM symbols in the time domain. A resource block is a resource allocation unit, and includes a plurality of OFDM symbols and a plurality of subcarriers. A frame can be composed of 10 ms, and can include 10 subframes composed of 1 ms. A number of slots corresponding to a subcarrier spacing may be included in the subframe.

The MAC layer performs priority control of data, retransmission process by hybrid ARQ (Hybrid Automatic Repeat reQuest (HARQ)), a random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size and modulation and coding scheme (MCS)) and resources to be allocated to the UE 100.

The RLC layer transmits data to the RLC layer on a reception side using the features of the MAC layer and the PHY layer. Data and control information are transmitted between the RLC layer of the UE 100 and the RLC layer of the base station 200 via a logical channel.

The PDCP layer performs header compression/decompression and encryption/decryption.

A SDAP (Service Data Adaptation Protocol) layer may be provided as an upper layer of the PDCP layer. The SDAP (Service Data Adaptation Protocol) layer performs mapping between an IP flow that is a unit in which a core network performs QoS (Quality of Service) control, and a radio bearer that is a unit in which an AS (Access Stratum) performs QoS control.

The RRC layer controls the logical channel, the transport channel, and the physical channel according to establishment, reestablishment, and release of the radio bearer. RRC signaling for various settings is transmitted between the RRC layer of the UE 100 and the RRC layer of the base station 200. In a case where there is an RRC connection between the RRC of the UE 100 and the RRC of the base station 200, the UE 100 is in an RRC connected state. In a case where there is no RRC connection between the RRC of the UE 100 and the RRC of the base station 200, the UE 100 is in an RRC idle state. In a case where an RRC connection between the RRC of the UE 100 and the RRC of the base station 200 is suspended, the UE 100 is in an RRC inactive state.

An NAS layer located above the RRC layer performs session management and mobility management of the UE 100. NAS signaling is transmitted between the NAS layer of the UE 100 and the NAS layer of the core network apparatus 300 (AMF). Note that the UE 100 has an application layer and the like other than a protocol of a radio interface.

### (Outline of Random Access Procedure)

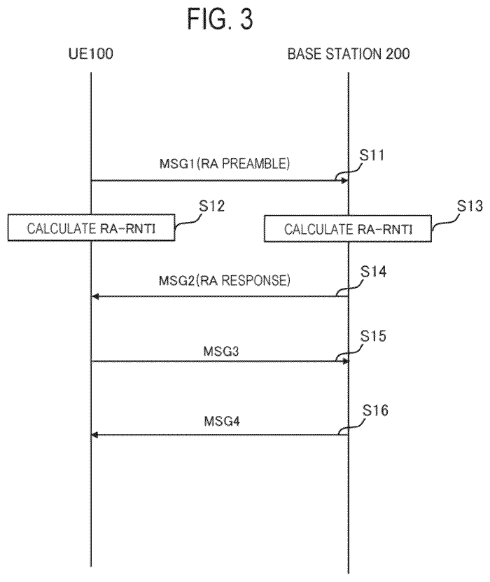

Next, an outline of the random access procedure will be described with reference to FIGS. 3 to 5. In the mobile communication system 1, as the random access procedure (hereinafter referred to as RA procedure), a 4-step random access type RA procedure (hereinafter referred to as a 4-step RA procedure) and a 2-step random access type RA procedure (hereinafter referred to as a 2-step RA procedure.) are supported. Message 1 (MSG1) is used in the 4-step RA procedure, and message A (MSGA) is used in the 2-step RA procedure. Note that in both RA procedures, contention-free random access (CFRA) and contention-based random access (CBRA) are supported.

FIG. 3 illustrates an operation example in the 4-step random access type CBRA.

### Step S11:

The UE 100 randomly selects one random access preamble (hereinafter, an RA preamble) from the random access preamble set prepared for the CBRA. The UE 100 transmits the selected RA preamble to the base station 200 on a physical random access channel (PRACH) at a PRACH occasion. The base station 200 receives the RA preamble from the UE 100. The RA preamble or its transmission in the 4-step RA procedure is called message 1 (MSG1).

### Step S12:

The UE 100 calculates a radio network temporary identifier (specifically, Random Access-Radio Network Temporary Identifier (RA-RNTI)) for identifying a random access response (hereinafter referred to as an RA response) which is a response with respect to the RA preamble. Specifically, the UE 100 calculates the RA-RNTI from the PRACH time-frequency index associated with the PRACH occasion (i.e., the location of the time-frequency resource). The UE 100 calculates the RA-RNTI in the 4-step RA procedure with the following calculation formula (Formula A).

$$RA - RNTI = 1 + s\_id + 14 \times t\_id + 14 \times 80 \times f\_id + 14 \times 80 \times 8 \times ul\_carrier \_id \qquad Formula A$$

s_id, t_id, f_id, and ul_carrier_id are referred to as PRACH time-frequency indexes. These indexes are 0 or a value of a natural number. s_id is an index of a first OFDM symbol of the PRACH occasion. The value range of s_id is larger than or equal to 0 and less than 14 (0≤s_id<14). t_id is an index of a first slot of the PRACH occasion in one system frame. The value range of t_id is larger than or equal to 0 and less than 80 (0≤ t_id<80). f_id is an index of the PRACH occasion in frequency domain. The value range of f_id is larger than or equal to 0 and less than 8 (0≤f_id<8). ul_carrier_id is an uplink carrier used for the RA preamble transmission. When the uplink carrier is a normal uplink (NUL) carrier, ul_carrier_id is 0. When the uplink carrier is a supplementary uplink (SUL) carrier, ul_carrier_id is 1.

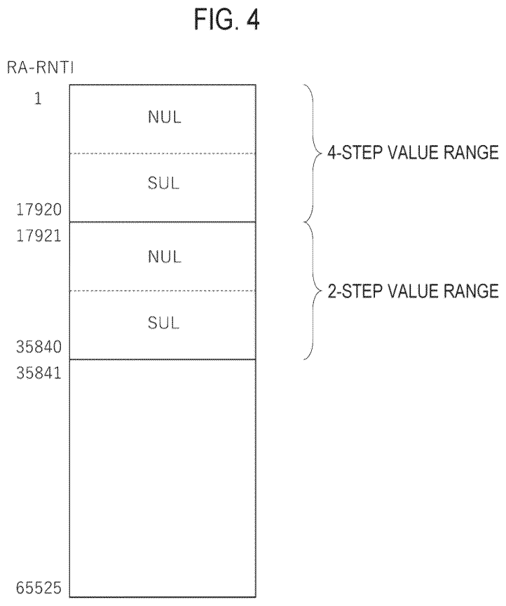

In the mobile communication system 1 in 3GPP, as illustrated in Table 1, values from 1 to 65522 (FFF2) are secured as radio network temporary identifiers (RNTI) including the RA-RNTI. Therefore, in the existing mobile communication system 1 in 3GPP, a value from 1 to a maximum of 65522 can be allocated as the RA-RNTI. In the existing technical specifications of 3GPP, the value range (hereinafter referred to as a 4-step value range) of RA-RNTI in the 4-step RA procedure is from 1 to 17920 (see FIG. 4).

TABLE 1

| Value (hexa-decimal) | RNTI |
|---|---|
| 0000 | N/A |
| 0001-FFF2 | RA-RNTI, MSGB-RNTI, Temporary C-RNTI, |
| | C-RNTI, CI-RNTI, MCS-C-RNTI, CS-RNTI, |
| | TPC-PUCCH-RNTI, TPC-PUSCH-RNTI, |
| | TPC-SRS-RNTI, INT-RNTI, SFI-RNTI, |
| | SP-CSI-RNTI, PS-RNTI, SL-RNTI, |
| | SLCS-RNTI SL Semi-Persistent Scheduling |
| | V-RNTI, and AI-RNTI |
| FFF3-FFFD | Reserved |
| FFFE | P-RNTI |
| FFFF | SI-RNTI |

### Step S13:

Similarly to the UE 100, the base station 200 calculates the RA-RNTI from the PRACH time-frequency index associated with the PRACH occasion that is the transmission occasion of the RA preamble.

### Step S14:

The base station 200 transmits the RA response to the UE 100 in response to the reception of the RA preamble from the UE 100. Here, the base station 200 scrambles the RA response with the RA-RNTI and transmits it. The UE 100 receives (decodes) the RA response from the base station 200 using the RA-RNTI. The RA response or its transmission in the 4-step RA procedure is called message 2 (MSG2).

The MSG2 includes preamble information indicating the RA preamble received from the UE 100, an uplink grant (UL grant), a timing advance value, and a temporary identifier. The preamble information is information indicating the RA preamble received from the UE 100. The UL grant is information indicating an UL-SCH resource (specifically, a PUSCH (Physical Uplink Access Channel) resource) used by the UE 100 to transmit the MSG3 to be described later. The timing advance value is a transmission timing alignment value for compensating for a propagation delay of a radio signal. The temporary identifier is a temporary C-RNTI (Cell-Radio Network Temporary Identifier) allocated to the UE 100 by the base station 200. When the RA preamble transmitted by the UE 100 that has received the RA response matches the RA preamble indicated by the preamble information received from the base station 200 in step S102, the UE proceeds the process to MSG3.

### Step S15:

In response to the reception of the RA response, the UE 100 transmits a message on the UL-SCH (PUSCH). When the information indicating the RA preamble transmitted by the UE 100 is included in the RA response, the UE transmits a message, specifically, an RRC message, to the base station by using the UL-SCH resource allocated by the UL grant. In the 4-step RA procedure, the message first scheduled by the base station 200 or its transmission is called message 3 (MSG3).

### Step S16:

The base station 200 transmits, to the UE 100, identification data (Contention Resolution) for contention resolution for the UE 100. The UE 100 receives the identification data from the base station 200. The identification data for contention resolution or transmission thereof in the 4-step RA procedure is called message 4 (MSG4).

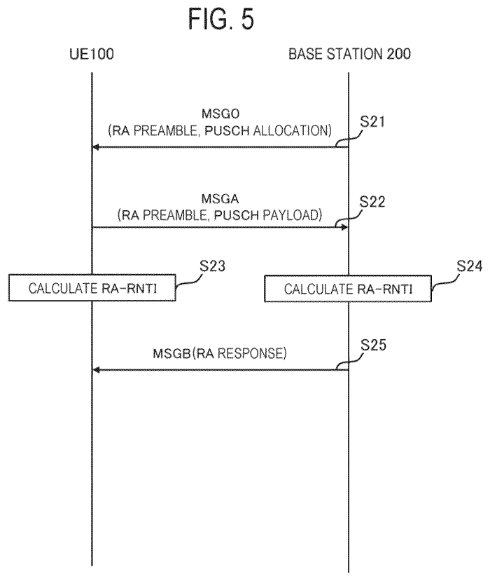

FIG. 5 illustrates an operation example in a 2-step random access type CFRA.

### Step S21:

The base station 200 transmits, to the UE 100, an RA preamble dedicated to the UE 100 and a PUSCH allocation that is a physical uplink shared channel (PUSCH) resource for MSGA transmission. The UE 100 receives the dedicated RA preamble and the PUSCH allocation from the base station 200. The dedicated RA preamble and PUSCH allocation or its transmission in the 2-step RA procedure is called message 0 (MSG0).

### Step S22:

The UE 100 transmits the RA preamble and the PUSCH payload received from the base station 200 to the base station 200 based on the PUSCH allocation. The base station 200 receives the RA preamble and the PUSCH payload from the UE 100. The RA preamble and the PUSCH payload or the transmission thereof in the 2-step RA procedure are called message A (MSGA).

### Step S23:

The UE 100 calculates a radio network temporary identifier (RA-RNTI) for identifying the RA response. Specifically, the UE 100 calculates the RA-RNTI in the 2-step RA procedure by the following calculation formula (Formula B). Note that the RA-RNTI in the 2-step RA procedure is referred to as MSGB-RNTI.

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2 \qquad Formula B$$

In the existing technical specifications of 3GPP, the value range (hereinafter referred to as a 2-step value range) of RA-RNTI (MSGB-RNTI) in the 2-step RA procedure is from 17921 to 35840 (see FIG. 4).

The UE 100 calculates the RA-RNTI from the PRACH time-frequency index associated with the PRACH occasion.

### Step S24:

Similarly to the UE 100, the base station 200 calculates the RA-RNTI from the PRACH time-frequency index associated with the PRACH occasion.

### Step S25:

The base station 200 transmits the RA response to the UE 100 in response to the reception of the RA preamble from the UE 100. Here, the base station 200 scrambles the RA response with the RA-RNTI and transmits it. The UE 100 receives (decodes) the RA response from the base station 200 using the RA-RNTI. The RA preamble or its transmission in the 2-step RA procedure is called message B (MSGB).

Note that the MSGB includes preamble information indicating the RA preamble received from the UE 100, an uplink grant, a timing advance value, and a temporary identifier. When the preamble information included in the RA response indicates the RA preamble transmitted by the UE 100, the UE 100 considers that the reception of the RA response is successful.

### (Rach Partitioning)

In recent years, there has been discussed a technique (so-called RACH partitioning) for notifying, so that the feature the user equipment requests to use (hereinafter referred to as request feature) among a plurality of features defined in a mobile communication system can be identified at an early stage to a network side, a request feature of the UE 100 in an RA procedure.

Here, the plurality of features are features notified to the network side in the RA procedure. The plurality of features may be, for example, a feature in which the capability of the UE 100 is reduced (RedCap: Reduced Capability), a small data feature (SmallData: SDT) for transmitting data to the network in the RA procedure, a coverage enhancement feature (CovEnh), and a network slicing feature (Slicing).

The request feature of the UE 100 may include at least any one of “RedCap”, “SDT” (or “SmallData”), “CovEnh”, and “Slicing”. If the request feature is “RedCap”, RACH indicates that the capability of the UE 100 is a reduced capability to the network 10 with MSG1 so that network 10 can adapt to subsequent transmissions. When the request feature is “SDT”, RACH requests a large MSG3 size (or a large MSGA size in the case of a 2-step RA procedure). When the request feature is “CovEnh”, RACH indicates necessity of coverage enhancement (in particular, request of repetition of MSG3). When the request feature is “Slicing”, RACH indicates a slice with a high priority to the network 10, and slice separation is realized even to the RACH.

In a case where a technique for notifying a request feature of the UE 100 in the RA procedure is introduced, it is conceivable to differ a value range of the RA-RNTI in each of a plurality of features by increasing an offset value used for calculation of the RA-RNTI according to a type of request feature that can be notified in order to avoid the overlapping problem of the RNTI.

However, the upper limit number that can be allocated as the RNTI is defined in the technical specification of 3GPP. For this reason, if the offset value is continuously increased according to the type of request feature that can be notified, the number of RA-RNTIs exceeds the upper limit number that can be allocated as the RNTI, and there is a concern that shortage (exhaustion) of the allocatable RNTI occurs. Therefore, it is required to calculate an appropriate RA-RNTI by a mechanism different from an existing RA-RNTI calculation method such as a 2-step RA procedure. Therefore, in an embodiment to be described later, an operation for calculation of an appropriate radio network temporary identifier that enables a random access response to be identified when notifying the network 10 of the request feature of the UE 100 in the RA procedure will be described.

### (Configuration of User Equipment)

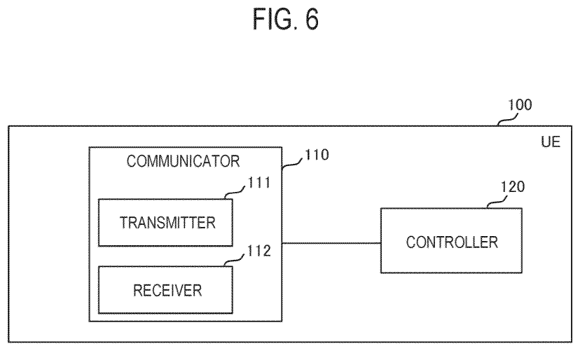

A configuration of the UE 100 according to the embodiment will be described with reference to FIG. 6. The UE 100 includes a communicator 110 and a controller 120.

The communicator 110 performs radio communication with the base station 200 by transmitting and receiving a radio signal to and from the base station 200. The communicator 110 includes at least one transmitter 111 and at least one receiver 112. The transmitter 111 and the receiver 112 may include a plurality of antennas and RF circuits. The antenna converts a signal into a radio wave and emits the radio wave into a space. Further, the antenna receives an electric wave in space and converts the electric wave into a signal. The RF circuit performs analog processing of a signal transmitted and received via the antenna. The RF circuit may include a high frequency filter, an amplifier, a modulator, a low pass filter, and the like.

The controller 120 performs various types of control in the UE 100. The controller 120 controls communication with the base station 200 via the communicator 110. The operation of the UE 100 described above and described later may be an operation under the control of the controller 120. The controller 120 may include at least one processor capable of executing a program and a memory that stores the program. The processor may execute the program to perform the operation of the controller 120. The controller 120 may include a digital signal processor that executes digital processing of the signal transmitted and received via the antenna and the RF circuit. The digital processing includes processing of the protocol stack of the RAN. Note that the memory stores a program executed by the processor, a parameter related to the program, and data related to the program. The memory may include at least one of an ROM (Read Only Memory), an EPROM (Erasable Programmable Read Only Memory), an EEPROM (Electrically Erasable Programmable Read Only Memory), an RAM (Random Access Memory), and a flash memory. All or a part of the memory may be included in the processor.

The UE 100 configured in this manner has at least one of a plurality of features defined in the mobile communication system 1. In the UE 100, the controller 120 selects the PRACH time-frequency index set corresponding to the request feature from a plurality of PRACH time-frequency index sets different for each combination of one or a plurality of features. The communicator 110 transmits the RA preamble to the base station 200 in a transmission occasion corresponding to the selected PRACH time-frequency index set. The controller 120 calculates an RA-RNTI (designated identifier) which is an RNTI for identifying the RA response from the base station 200 from the selected PRACH time-frequency index set through a designated calculation formula. The designated calculation formula is configured to calculate the RA-RNTI (designated identifier) within a specific value range that is outside the value range of the RA-RNTI in the 4-step RA procedure. As a result, even if the offset value is not increased according to the type of request feature that can be notified, the UE 100 that has transmitted the RA preamble in order to notify the network of the request feature can be suppressed from receiving the RA response addressed to another UE 100 that has calculated the RA-RNTI within the value range of the RA-RNTI in the 4-step RA procedure. As described above, when notifying the network 10 of the request feature of the UE 100 in the RA procedure, the UE 100 can calculate an appropriate RA-RNTI.

Furthermore, in the UE 100, the communicator 110 receives, from the base station 200, a message indicating a correspondence relationship between a combination of one or a plurality of features and a plurality of PRACH time-frequency index sets different for each combination. The controller 120 selects the PRACH time-frequency index set corresponding to the request feature in which the UE 100 requests for use from the plurality of PRACH time-frequency index sets based on the correspondence relationship. The controller 120 calculates an RA-RNTI (designated identifier) which is an RNTI for identifying the RA response from the base station 200 from the selected PRACH time-frequency index set through a designated calculation formula. As a result, the UE 100 can select the PRACH time-frequency index set based on the correspondence relationship. Since the PRACH time-frequency index set selected by the UE 100 is different from the PRACH time-frequency index set selected by the UE 100 having a different request feature, the RA-RNTI is not the same, and an appropriate RA-RNTI can be calculated. In addition, the network 10 can flexibly set a correspondence relationship between a combination of one or a plurality of features and a plurality of PRACH time-frequency index sets different for each combination. As a result, for example, for a feature that is frequently requested from the UE 100, the number of corresponding PRACH time-frequency index sets can be increased, and the radio resources can be effectively utilized.

### (Configuration of Base Station)

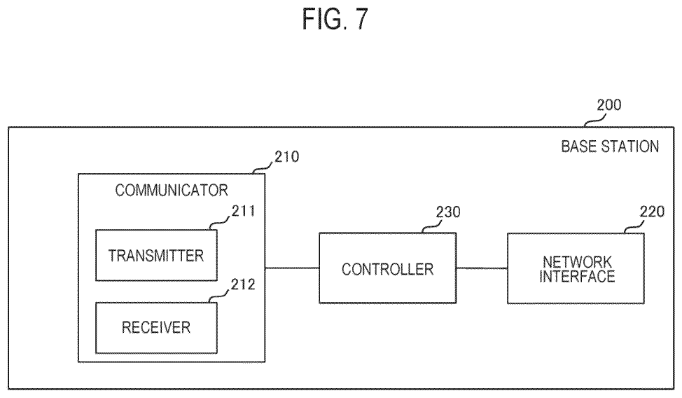

A configuration of the base station 200 according to the embodiment will be described with reference to FIG. 7. The base station 200 includes a communicator 210, a network interface 220, and a controller 230.

For example, the communicator 210 receives a radio signal from the UE 100 and transmits a radio signal to the UE 100. The communicator 210 includes at least one transmitter 211 and at least one receiver 212. The transmitter 211 and the receiver 212 may include an RF circuit. The RF circuit performs analog processing of a signal transmitted and received via the antenna. The RF circuit may include a high frequency filter, an amplifier, a modulator, a low pass filter, and the like.

The network interface 220 transmits and receives a signal to and from a network. The network interface 220 receives, for example, a signal from a neighboring base station connected via an Xn interface, which is an interface between base stations, and transmits the signal to the neighboring base station. In addition, the network interface 220 receives a signal from a core network apparatus 300 connected via the NG interface, for example, and transmits a signal to the core network apparatus 300.

The controller 230 performs various types of control in the base station 200. The controller 230 controls, for example, communication with the UE 100 via the communicator 210. Furthermore, the controller 230 controls, for example, communication with a node (e.g., the neighboring base station and the core network apparatus 300) via the network interface 220. The operation of the base station 200 described above and described later may be an operation under the control of the controller 230. The controller 230 may include at least one processor capable of executing a program and a memory that stores the program. The processor may execute the program to perform the operation of the controller 230. The controller 230 may include a digital signal processor that executes digital processing of a signal transmitted and received via the antenna and the RF circuit. The digital processing includes processing of the protocol stack of the RAN. Note that the memory stores a program executed by the processor, a parameter related to the program, and data related to the program. All or a part of the memory may be included in the processor.

The base station 200 configured in this manner performs radio communication with the UE 100 having at least one feature among a plurality of features defined in the mobile communication system 1. In the base station 200, the communicator 210 receives the RA preamble transmitted from the UE 100 using the PRACH time-frequency index set selected based on the request feature in which the UE 100 requests for use from a plurality of PRACH time-frequency index sets different for each combination of one or a plurality of features. The controller 230 calculates an RA-RNTI (designated identifier), which is a radio network temporary identifier for identifying the RA response to the UE 100, from the PRACH time-frequency index set used for transmission of the RA preamble through a designated calculation formula. The designated calculation formula is configured to calculate the RA-RNTI (designated identifier) within a specific value range that is outside the value range of the RA-RNTI in the 4-step RA procedure. As a result, the UE 100 that has transmitted the RA preamble in order to notify the request feature to the network can be suppressed from receiving the RA response addressed to another UE 100 that has calculated the RA-RNTI within the value range of the RA-RNTI in the 4-step RA procedure. As described above, when notifying the network 10 of the request feature of the UE 100 in the RA procedure, the UE 100 can calculate an appropriate RA-RNTI.

Furthermore, in the base station 200, the controller 230 generates a message indicating a correspondence relationship between a combination of one or a plurality of features and a plurality of PRACH time-frequency index sets different for each combination. The communicator 110 transmits the message to the UE 100. As a result, the UE 100 can select the PRACH time-frequency index set based on the correspondence relationship. Since the PRACH time-frequency index set selected by the UE 100 is different from the PRACH time-frequency index set selected by the UE 100 having a different request feature, the RA-RNTI is not the same, and an appropriate RA-RNTI can be calculated. In addition, the network 10 can flexibly set a correspondence relationship between a combination of one or a plurality of features and a plurality of PRACH time-frequency index sets different for each combination. As a result, for example, for a feature that is frequently requested from the UE 100, the number of corresponding PRACH time-frequency index sets can be increased, and the radio resources can be effectively utilized.

### (Operation of Mobile Communication System)

### (1) First Operation Example

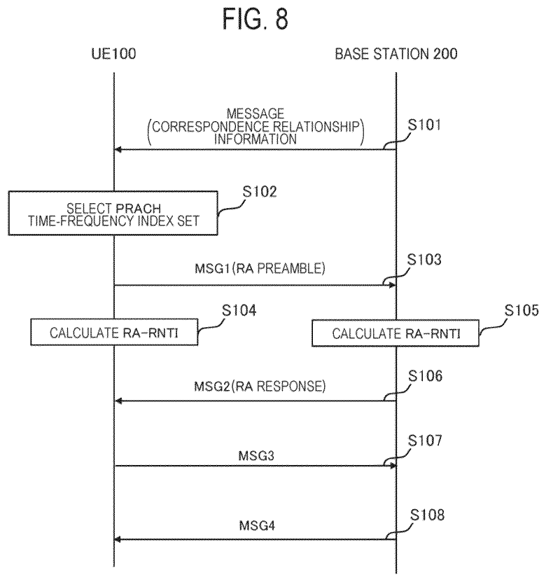

A first operation example of the mobile communication system 1 will be described with reference to FIGS. 8 to 10. Note that differences from the above-described operation example will be mainly described. In the present operation example, the sequence of the 4-step RA procedure will be described as an example, but it may be applied to the sequence of the 2-step RA procedure.

As illustrated in FIG. 8, in step S101, the base station 200 (controller 230) generates a message indicating correspondence relationship between a combination of one or a plurality of features and a plurality of PRACH time-frequency index sets different for each combination. The base station 200 (communicator 210) transmits the generated message to the UE 100. The UE 100 (communicator 110) receives the message from the base station 200.

The message may be a dedicated message dedicatedly transmitted to the UE 100. The message may be, for example, an RRC message. Alternatively, the message may be a broadcast message transmitted by broadcast. The message may be, for example, a system information block message.

The base station 200 (controller 230) may generate a message including correspondence relationship information as the message. The correspondence relationship information indicates a correspondence relationship between a combination of one or a plurality of features and a plurality of PRACH time-frequency index sets different for each combination.

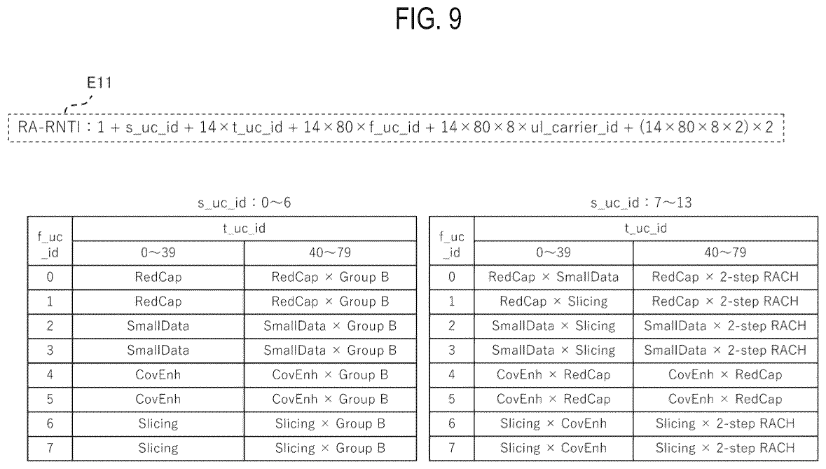

In FIG. 9, examples of a combination of one or a plurality of features include “RedCap”, “SmallData”, “CovEnh”, “Slicing”, “RedCap×GroupB”, “SmallData×GroupB”, “CovEnh×GroupB”, “Slicing×GroupB”, “RedCap×SmallData”, “RedCap×Slicing”, “SmallData×Slicing”, “CovEnh×RedCap”, “Slicing×CovEnh”, “RedCap×2-step RACH”, “SmallData×2-step RACH”, and “Slicing×2-step RACH″.

When the request feature is “GroupB”, a large MSG3 size is requested in the CBRA by the RACH. The UE 100 (controller 120) can select the RA preamble from the preamble group B when the MSG3 size is larger than the message size set in the system information. When the request feature is “2-step RACH”, the RACH indicates that the procedure is a 2-step RA procedure.

The PRACH time-frequency index set may include s_id (hereinafter may be referred to as a first time index) indicating a time resource position (first OFDM symbol) of the RA preamble, t_id (hereinafter may be referred to as a second time index) indicating a time resource position (first slot) of the RA preamble, f_id (hereinafter may be referred to as a frequency index) indicating a frequency resource position of the RA preamble, and ul_carrier_id (hereinafter may be referred to as a carrier index) indicating a transmission carrier of the RA preamble. In FIG. 9, for example, 0 to 6 of s_id, 0 to 39 of t_id, and 0 of f_id are associated with “RedCap”.

The base station 200 (controller 230) may include the correspondence relationship information in, for example, a RACH common configuration information element (RACH-ConfigCommon information element) in the system information block (SIB1). In addition, the base station 200 (controller 230) may include the correspondence relationship information in the information element related to the RACH resource in the RRC reconfiguration message.

In step S102, the UE 100 (controller 120) selects the PRACH time-frequency index set corresponding to the request feature in which the UE 100 requests for use from a plurality of PRACH time-frequency index sets different for each combination of one or a plurality of features. In the present operation example, the UE 100 (controller 120) selects the PRACH time-frequency index set corresponding to the request feature from the PRACH time-frequency index sets indicated by the correspondence relationship information.

When requesting for use of one feature, the UE 100 (controller 120) selects the PRACH time-frequency index set (e.g., s_id is 0, t_id is 0, and f_id is 0) from the PRACH time-frequency index sets associated with one feature (e.g., “RedCap”) instead of a combination of a plurality of features. On the other hand, when requesting for use of a plurality of features, that is, when the request feature is in plurals, the UE 100 (controller 120) selects the PRACH time-frequency index set (e.g., s_id is 7, t_id is 0, and f_id is 1) from the PRACH time-frequency index sets associated with the combination (e.g., “RedCap×Slicing”) of the plurality of features.

In step S103, the UE 100 (communicator 110) transmits the MSG1 (RA preamble) to the base station 200 in the transmission occasion corresponding to the selected PRACH time-frequency index set. Therefore, the UE 100 (communicator 110) transmits the RA preamble to the base station 200 using the selected PRACH time-frequency index set. The base station 200 (communicator 210) receives the RA preamble from the UE 100.

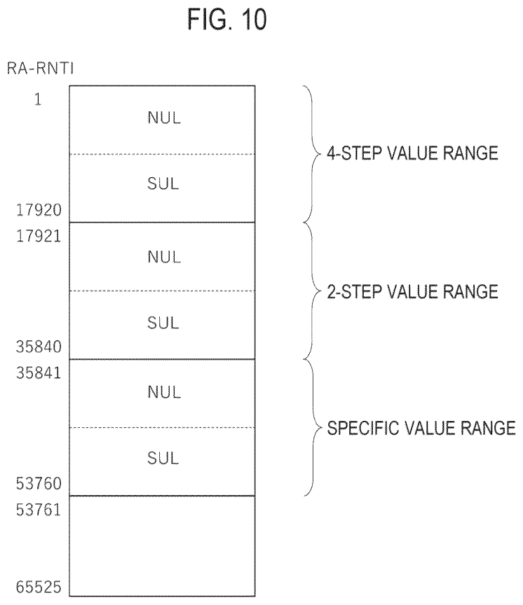

In step S104, the UE 100 (controller 120) calculates the RA-RNTI (designated identifier) from the selected PRACH time-frequency index set through a designated calculation formula. The designated calculation formula is configured to calculate the RA-RNTI within a specific value range that is outside the 4-step value range. In the present operation example, the designated calculation formula is formula E11 illustrated in FIG. 9. As illustrated in FIG. 10, the specific value range is a value range not included in either the 4-step value range or the 2-step value range. In the present operation example, the specific value range is 35841 to 53760. Note that the PRACH time-frequency index set used to calculate the RA-RNTI included in the 4-step value range and the 2-step value range is an index set not associated with a combination of one or a plurality of features.

The RA-RNTI (designated identifier) within the specific value range may be a name other than the RA-RNTI.

Formula E11 includes a specific term corresponding to the first time index, a specific term corresponding to the second time index, a specific term corresponding to the frequency index, and a specific term corresponding to the carrier index. Formula E11 includes an offset value set such that the RA-RNTI calculated according to formula E11 falls within the specific value range. The offset value is a fixed value that does not include a variable. In formula E11, since the offset value is “(14×80×8×2)×2” (=35840), even if the calculated value itself calculated by the PRACH time-frequency index set is within the 4-step value range or the 2-step value range, the RA-RNTI becomes a value within a range of 35841 to 53760 depending on the offset value.

In step S105, similarly to the UE 100 in step S104, the base station 200 (controller 230) calculates the RA-RNTI from the PRACH time-frequency index set used for the transmission of the RA preamble according to formula E11.

In addition, the base station 200 (controller 230) may grasp the request feature of the UE 100 based on the PRACH time-frequency index set used for the transmission of the RA preamble and the correspondence relationship information.

Steps S106 to S108 are similar to steps S14 to S16.

As described above, the UE 100 (controller 120) selects the PRACH time-frequency index set corresponding to the request feature from a plurality of PRACH time-frequency index sets different for each combination of one or a plurality of features. The UE 100 (communicator 110) transmits the RA preamble to the base station 200 in the transmission occasion corresponding to the selected PRACH time-frequency index set. The UE 100 (controller 120) calculates the RA-RNTI from the selected PRACH time-frequency index set according to formula E11. In addition, the base station 200 (controller 230) calculates the RA-RNTI from the PRACH time-frequency index set used for the transmission of the RA preamble according to formula E11. Formula E11 is configured to calculate the RA-RNTI within a specific value range that is outside the 4-step value range. As a result, the UE 100 that has transmitted the RA preamble in order to notify the request feature to the network can be suppressed from receiving the RA response addressed to another UE 100 that has calculated the RA-RNTI within the value range of the RA-RNTI in the 4-step RA procedure. As described above, when notifying the network 10 of the request feature of the UE 100 in the RA procedure, the UE 100 can calculate an appropriate RA-RNTI.

In addition, the base station 200 (controller 230) generates a message indicating a correspondence relationship between a combination of one or a plurality of features and a plurality of PRACH time-frequency index sets different for each combination. The base station 200 (communicator 210) transmits the message to the UE 100. The UE 100 (communicator 110) receives the message indicating the correspondence relationship. The UE 100 (controller 120) selects the PRACH time-frequency index set corresponding to the request feature in which the UE 100 requests for use from the plurality of PRACH time-frequency index sets based on the correspondence relationship. The UE 100 (controller 120) calculates the RA-RNTI from the selected PRACH time-frequency index set according to formula E11. As a result, the UE 100 can select the PRACH time-frequency index set based on the correspondence relationship. Since the PRACH time-frequency index set selected by the UE 100 is different from the PRACH time-frequency index set selected by the UE 100 having a different request feature, the RA-RNTI is not the same, and an appropriate RA-RNTI can be calculated. In addition, the network 10 can flexibly set a correspondence relationship between a combination of one or a plurality of features and a plurality of PRACH time-frequency index sets different for each combination. As a result, for example, for a feature that is frequently requested from the UE 100, the number of corresponding PRACH time-frequency index sets can be increased, and the radio resources can be effectively utilized.

The specific value range may be a value range not included in either the 4-step value range or the 2-step value range. Thus, thus the UE 100 that has transmitted the RA preamble in order to notify the network of the request feature can be suppressed from receiving the RA response addressed to another UE 100 that has calculated the RA-RNTI within the 4 step value range or the 2 step value range. As described above, when notifying the network 10 of the request feature of the UE 100 in the RA procedure, the UE 100 can calculate an appropriate RA-RNTI.

In addition, formula E11 may include an offset value set so that the RA-RNTI calculated by formula E11 falls within a specific value range.

In addition, the message indicating the correspondence relationship is a dedicated message dedicatedly transmitted to the UE 100. As a result, the network 10 can limit the UE 100 that selects the PRACH time-frequency index set corresponding to the request feature, and control by the network 10 is facilitated.

Furthermore, the message indicating the correspondence relationship may be a broadcast message transmitted by broadcast. As a result, the base station 200 does not need to transmit the message indicating the correspondence relationship to each of the plurality of UEs 100, and can effectively utilize the radio resources. In particular, when the broadcast message is a system information block (SIB) message, even the UE 100 in the RRC idle state or the RRC inactive state can receive the message indicating the correspondence relationship.

### (2) Second Operation Example

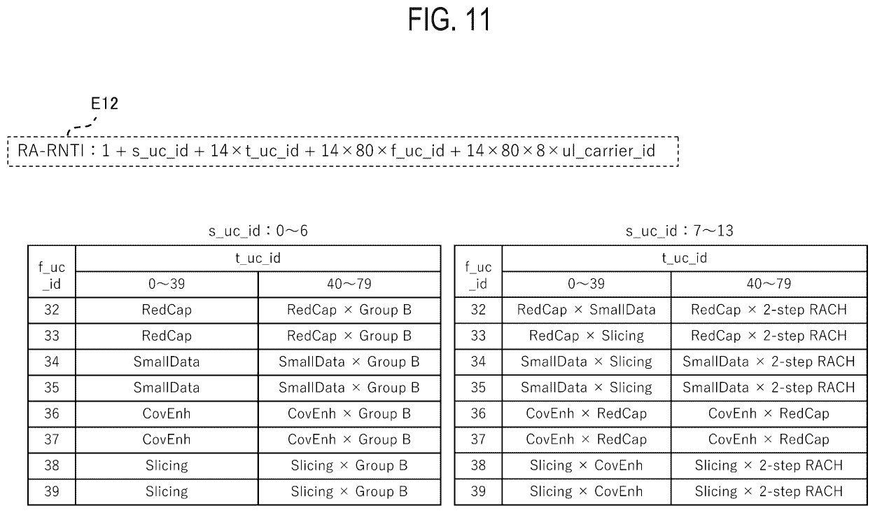

With reference to FIGS. 8 and 11, the second operation example will be described focusing on differences from the above-described operation example. In the second operation example, formula E12, which is the designated calculation formula, does not include the offset value of formula E11. The specific term corresponding to the frequency index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 11.

In the present operation example, the value range of the first time index (s_id) and the value range of the second time index (t_id) are the same as those in the first operation example. On the other hand, the value range of the frequency index (f_id) is larger than or equal to 32 and less than 40 (32≤f_id<40).

In step S104, the UE 100 (controller 120) calculates the RA-RNTI (designated identifier) from the selected PRACH time-frequency index set according to formula E12 (see FIG. 11), which is a designated calculation formula. Formula E12 includes a specific term corresponding to the frequency index. In this operation example, the specific term is “14×80×f_uc_id”. Since the value range of the frequency index (f_id) is larger than or equal to 32 and less than 40, the value range of a specific term is larger than or equal to 35840 and less than or equal to 43680. Accordingly, the specific term is configured such that the RA-RNTI calculated by formula E12 falls within the specific value range. As a result, since the value of the frequency index selected by the UE 100 (controller 120) is different from the value of the frequency index in the existing 4-step RA procedure, the RA-RNTI calculated by each of the UE 100 and the other UE 100 that performs the existing 4-step RA procedure is different. As a result, it is possible to suppress the reception of the RA response addressed to the UE 100 and the other UE 100.

### (3) Third Operation Example

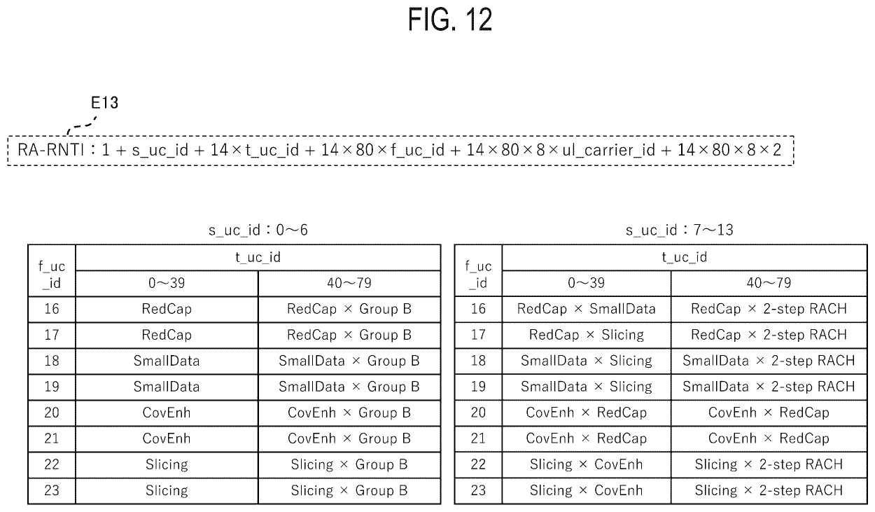

With reference to FIGS. 8 and 12, the third operation example will be described focusing on differences from the above-described operation examples. In the third operation example, formula E13, which is a designated calculation formula, includes an offset value and a specific term corresponding to an offset value and a frequency index. The specific term corresponding to the offset value and the frequency index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 12.

In the present operation example, the value range of the first time index (s_id) and the value range of the second time index (t_id) are the same as those in the first operation example. On the other hand, the value range of the frequency index (f_id) is larger than or equal to 16 and less than 24 (16≤f_id<24).

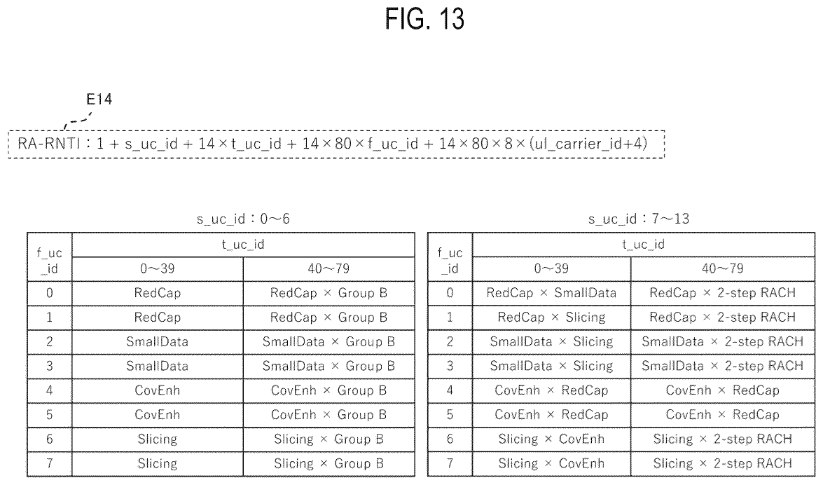

In step S104, the UE 100 (controller 120) calculates the RA-RNTI (designated identifier) from the selected PRACH time-frequency index set according to formula E13 (see FIG. 13), which is a designated calculation formula. Formula E13 includes a specific term corresponding to the frequency index. In this operation example, the specific term is “14×80 xf_uc_id”. Since the value range of the frequency index (f_id) is larger than or equal to 16 and less than 24, the value range of a specific term is larger than or equal to 17920 and less than or equal to 25760. In formula E13, the offset value is “14×80×8×2” (=17920). Therefore, since the total value of the specific term and the offset value is larger than or equal to 35840, the specific term and the offset value are configured such that the RA-RNTI calculated by formula E13 falls within the specific value range. As a result, since the value of the frequency index selected by the UE 100 (controller 120) is different from the value of the frequency index in the existing 4-step RA procedure, the RA-RNTI calculated by each of the UE 100 and the other UE 100 that performs the existing 4-step RA procedure is different. As a result, it is possible to suppress the reception of the RA response addressed to the UE 100 and the other UE 100.

### (4) Fourth Operation Example

With reference to FIGS. 8 and 13, the fourth operation example will be described focusing on differences from the above-described operation examples. In the fourth operation example, formula E14, which is a designated calculation formula, includes a specific term corresponding to the carrier index. The specific term corresponding to the carrier index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 13.

In step S104, the UE 100 (controller 120) calculates the RA-RNTI (designated identifier) from the selected PRACH time-frequency index set according to formula E14 (see FIG. 13), which is a designated calculation formula. Formula E14 includes a specific term corresponding to the carrier index. In the present operation example, the specific term is “14×80×8×(ul_carrier_id+4)”. Since the carrier index is 0 or 1, the value range of the specific term is larger than or equal to 35840 and less than or equal to 44800. Accordingly, the specific term is configured such that the RA-RNTI calculated by formula E14 falls within the specific value range. As a result, since the value of the frequency index selected by the UE 100 (controller 120) is different from the value of the frequency index in the existing 4-step RA procedure, the RA-RNTI calculated by each of the UE 100 and the other UE 100 that performs the existing 4-step RA procedure is different. As a result, it is possible to suppress the reception of the RA response addressed to the UE 100 and the other UE 100.

### (5) Fifth Operation Example

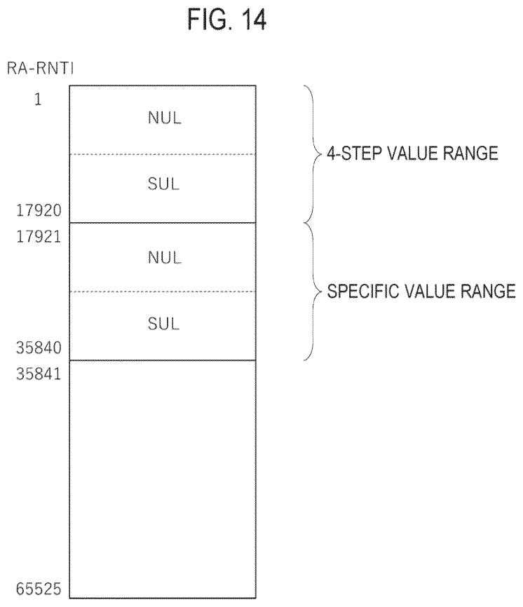

With reference to FIGS. 8, 14 and 15, a fifth operation example will be described focusing on differences from the above-described operation examples. In the fifth operation example, as illustrated in FIG. 14, the specific value range is 17921 to 35840. Therefore, the specific value range is the same as the 2-step value range.

In this operation example, in the cell managed by the base station 200, the 2-step RA procedure, which is an optional operation in the 3GPP mobile communication system 1, is not performed.

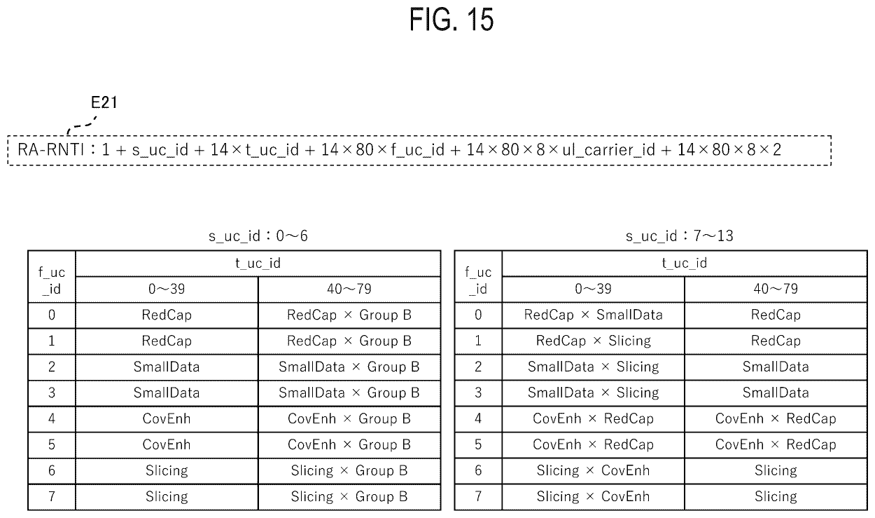

In step S102, the UE 100 (controller 120) selects the PRACH time-frequency index set corresponding to the request feature from the plurality of PRACH time-frequency index sets as illustrated in FIG. 15. In the present operation example, the value range of each index of the PRACH time-frequency index set is similar to that in the first operation example.

In step S104, the UE 100 (controller 120) calculates the RA-RNTI (designated identifier) from the selected PRACH time-frequency index set according to formula E21 (see FIG. 15), which is a designated calculation formula. Formula E21 includes an offset value set such that the RA-RNTI calculated according to formula E21 falls within the specific value range. In formula E21, the offset value is “14×80×8×2” (=17920). As a result, even when the calculated value itself calculated by the PRACH time-frequency index set is within the 4-step value range, as illustrated in FIG. 14, the RA-RNTI becomes a value within 17921 to 35840 by the offset value. Therefore, the specific value range is the same as the 2-step value range. As a result, values from 35841 to 65522 can be secured as values that can be allocated to other RNTIs.

### (6) Sixth Operation Example

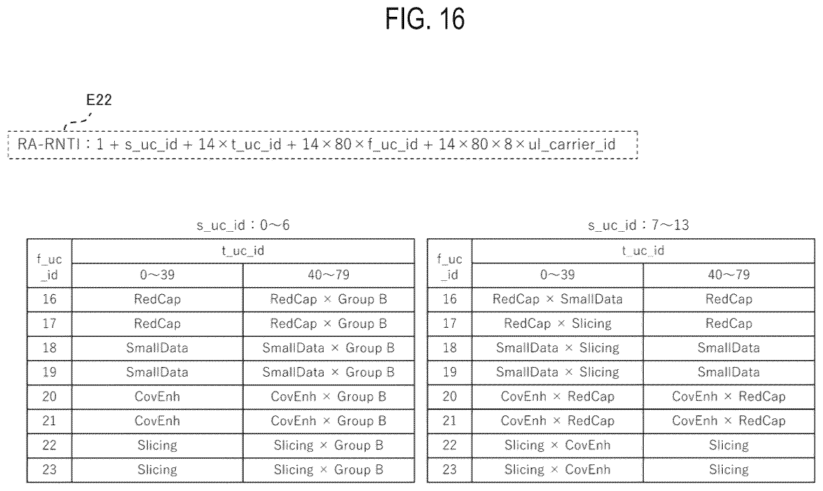

With reference to FIGS. 8 and 16, the sixth operation example will be described focusing on differences from the above-described operation examples. In the present operation example, as in the fifth operation example, the specific value range is 17921 to 35840. On the other hand, in the present operation example, formula E22, which is the designated calculation formula, does not include the offset value of formula E21. The specific term corresponding to the frequency index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 11.

In the present operation example, the value range of the first time index (s_id) and the value range of the second time index (t_id) are the same as those in the first operation example. On the other hand, the value range of the frequency index (f_id) is larger than or equal to 16 and less than 24 (16≤f_id<24).

In step S104, the UE 100 (controller 120) calculates the RA-RNTI (designated identifier) from the selected PRACH time-frequency index set according to formula E22 (see FIG. 16), which is a designated calculation formula. Formula E22 includes a specific term corresponding to the frequency index. In this operation example, the specific term is “14×80×f_uc_id”. Since the value range of the frequency index (f_id) is larger than or equal to 16 and less than 24, the value range of a specific term is larger than or equal to 17920 and less than or equal to 25760. Accordingly, the specific term is configured such that the RA-RNTI calculated by formula E22 falls within the specific value range. As a result, similarly to the second operation example, it is possible to suppress the reception of the RA response addressed to the UE 100 and the other UE 100.

### (7) Seventh Operation Example

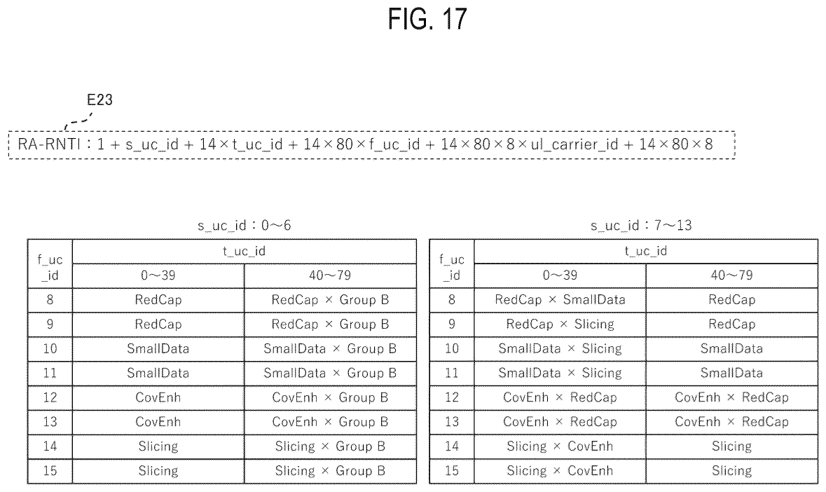

With reference to FIGS. 8 and 17, the seventh operation example will be described focusing on differences from the above-described operation examples. In the present operation example, as in the fifth operation example, the specific value range is 17921 to 35840. On the other hand, in the present operation example, formula E23, which is a designated calculation formula, includes an offset value and a specific term corresponding to the frequency index. The specific term corresponding to the offset value and the frequency index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 17.

In the present operation example, the value range of the first time index (s_id) and the value range of the second time index (t_id) are the same as those in the first operation example. On the other hand, the value range of the frequency index (f_id) is larger than or equal to 8 and less than 16 (8≤f_id<16).

In step S104, the UE 100 (controller 120) calculates the RA-RNTI (designated identifier) from the selected PRACH time-frequency index set according to formula E23 (see FIG. 17), which is a designated calculation formula. Formula E23 includes a specific term corresponding to the frequency index. In this operation example, the specific term is “14×80×f_uc_id”. Since the value range of the frequency index (f_id) is larger than or equal to 8 and less than 16, the value range of a specific term is larger than or equal to 8960 and less than or equal to 16800. In formula E23, the offset value is “14×80×8” (=8960). Therefore, since the total value of the specific term and the offset value is larger than or equal to 17920, the specific term and the offset value are configured such that the RA-RNTI calculated by formula E23 falls within the specific value range. As a result, similarly to the third operation example, it is possible to suppress the reception of the RA response addressed to the UE 100 and the other UE 100.

### (8) Eighth Operation Example

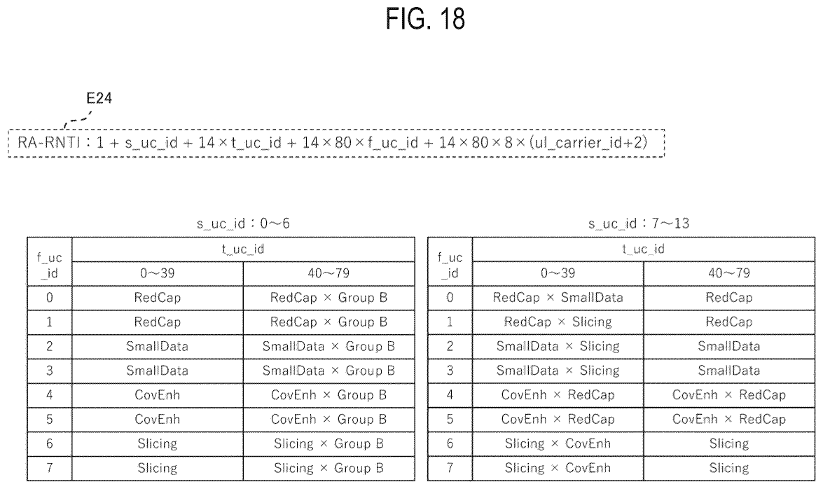

With reference to FIGS. 8 and 18, the eighth operation example will be described focusing on differences from the above-described operation examples. In the present operation example, as in the fifth operation example, the specific value range is 17921 to 35840. On the other hand, In the present operation example, formula E24, which is a designated calculation formula, includes a specific term corresponding to the carrier index. The specific term corresponding to the carrier index is configured such that the RA-RNTI falls within a specific value range.

In step S102, the UE 100 (controller 120) selects the PRACH time-frequency index set corresponding to the request feature from the plurality of PRACH time-frequency index sets as illustrated in FIG. 18.

In step S104, the UE 100 (controller 120) calculates the RA-RNTI (designated identifier) from the selected PRACH time-frequency index set according to formula E24 (see FIG. 18), which is a designated calculation formula. Formula E24 includes a specific term corresponding to the carrier index. In the present operation example, the specific term is “14×80×8×(ul_carrier_id+2)”. Since the carrier index is 0 or 1, the value range of the specific term is larger than or equal to 17920 and less than or equal to 26880. Accordingly, the specific term is configured such that the RA-RNTI calculated by formula E24 falls within the specific value range. As a result, similarly to the fourth operation example, it is possible to suppress the reception of the RA response addressed to the UE 100 and the other UE 100.

### (9) Ninth Operation Example

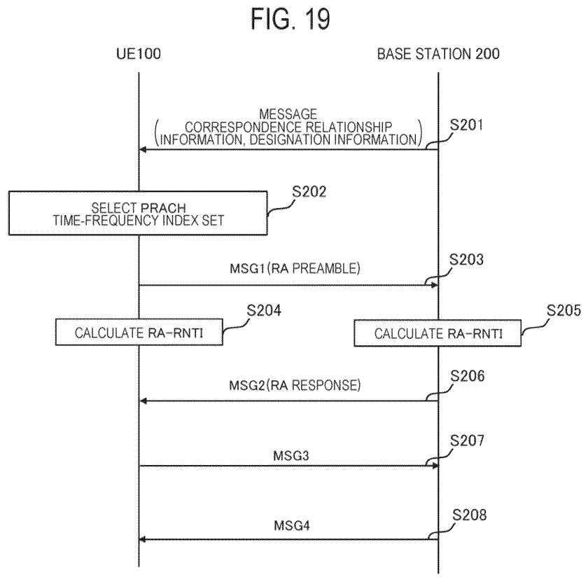

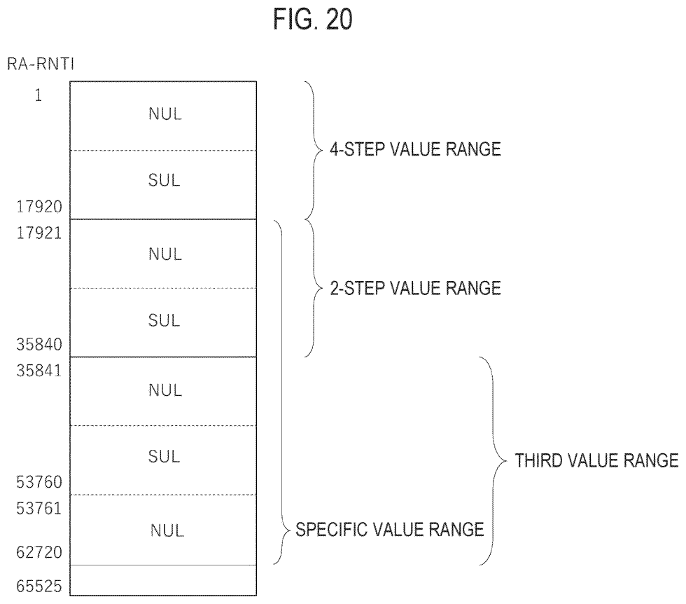

With reference to FIGS. 19 and 20, the ninth operation example will be described focusing on differences from the above-described operation examples. In the present operation example, the RA-RNTI (designated identifier) falls within either the 2-step value range or the value range different from the 4-step value range and the 2-step value range.

In step S201, the base station 200 (controller 230) generates a message including correspondence relationship information, similarly to the first operation example. The base station 200 (communicator 210) transmits the generated message to the UE 100.

The base station 200 (the controller 230) may include the designation information in the generated message. As a result, the base station 200 (communicator 210) can transmit the designation information to the UE 100. The UE 100 (communicator 110) receives the designation information from the base station 200. Note that the base station 200 (controller 230) may transmit the designation information to the UE 100 by a message different from the message including the correspondence relationship information. The message may be a dedicated message (e.g., RRC message) dedicatedly transmitted to the UE 100, or may be a broadcast message (e.g., SIB message) transmitted by broadcast.

In the present operation example, the designation information designates a designated index (hereinafter, it may be referred to as multi_uc_id) different from the PRACH time-frequency index set. A value range of the designated index is larger than or equal to 1 and less than or equal to 3 (1≤ multi_uc_id≤3).

In step S202, the UE 100 (controller 120) selects the PRACH time-frequency index set corresponding to the request feature similarly to the first operation example.

Step S203 is similar to step S103.

In step S204, the UE 100 (controller 120) calculates the RA-RNTI (designated identifier) from the selected PRACH time-frequency index set according to the following calculation formula (formula E31).

$$RA - RNTI : 1 + s\_id + 14 \times t\_id + 14 \times 80 \times f\_id + 14 \times 80 \times 8 \times ul\_carrier \_id + 14 \times 80 \times 8 \times 2 \times multi\_uc \_id \qquad Formula E31$$

A value range of s_id is larger than or equal to 0 and less than 14 (0≤s_id<14), a value range of t_id is larger than or equal to 0 and less than 80 (0≤t_id<80), and a value range of f_id is larger than or equal to 0 and less than 8 (0≤f_id<8).

Formula E31 includes a specific term corresponding to a designated index. As illustrated in FIG. 20, the specific term is configured such that the RA-RNTI (designated identifier) falls within either the 2-step value range or the value range (hereinafter referred to as third value range)

different from the 4-step value range and the 2-step value range.

In the present operation example, the specific term is “14×80×8×2×multi_uc_id”. The UE 100 (controller 120) calculates the value of the specific term based on the value of the designated index indicated by the designation information. When the designated index is 1, the specific term is 17920. Therefore, the RA-RNTI calculated by formula 31 falls within the 2-step value range. When the designated index is 2, the specific term is 35840. Therefore, the RA-RNTI calculated by formula 31 falls within the third value range. Specifically, the RA-RNTI falls within a value range of 35841 to 53760. When the designated index is 3, the specific term is 53760. The RA-RNTI calculated by formula 31 falls within the third value range.

Here, in a case where the designated index is 3, when the UE 100 (controller 120) selects the auxiliary uplink (SUL) carrier as the uplink carrier, the RA-RNTI calculated by formula E31 may exceed 65522, which is the maximum value that can be allocated as the RNTI, since the carrier index (ul_carrier_id) is 1. Therefore, when the designated index is 3, only the normal uplink (NUL) carrier may be selectable as the uplink carrier. In this case, the RA-RNTI falls within a value range of 53761 to 62720.

In step S205, similarly to the UE 100 in step S204, the base station 200 (controller 230) calculates the RA-RNTI from the PRACH time-frequency index set used for the transmission of the RA preamble according to formula E31.

In addition, similarly to step S105, the base station 200 (controller 230) may grasp the request feature of the UE 100 based on the PRACH time-frequency index set used for the transmission of the RA preamble and the correspondence relationship information.

Steps S206 to S208 are similar to steps S14 to S16.

As described above, formula E31 may include a specific term corresponding to a designated index different from the PRACH time-frequency index set. The specific term may be configured such that the RA-RNTI (designated identifier) falls within either the 2-step value range or the third value range. As a result, the value range that can be taken by the RA-RNTI (designated identifier) can be widened, so that the radio resources can be effectively utilized.

In addition, the UE 100 (communicator 110) may receive designation information designating a designated index from the base station 200. As a result, the network 10 can flexibly set the value range of the RA-RNTI (designated identifier).

### (10) Tenth Operation Example

With reference to FIGS. 19 and 20, the tenth operation example will be described focusing on differences from the above-described operation examples. In the present operation example, the specific term corresponding to the frequency index is configured such that the RA-RNTI (designated identifier) falls within either the 2-step value range or the third value range.

In step S201, when the value range of the frequency index is defined by a variable, the base station 200 (controller 230) may include designation information for designating the variable in the message as the designation information. For example, the value range of the frequency index may be defined by “8×2n≤f_mu_id≤8×2n+7”. Here, n is a variable. The value range of n is larger than or equal to 1 and less than or equal to 3 (1≤ n≤3).

The UE 100 (controller 120) calculates the RA-RNTI (designated identifier) from the selected PRACH time-frequency index set according to the following calculation formula (formula E32).

$$RA - RNTI : 1 + s\_mu \_id + 14 \times t\_mu \_id + 14 \times 80 \times f\_mu \_id + 14 \times 80 \times 8 \times ul\_carrier \_id \qquad Formula E32$$

Note that the value range of s_id is larger than or equal to 0 and less than 14 (0≤ s_id<14), and the value range of t_id is larger than or equal to 0 and less than 80 (0≤t_id<80).

Formula E32 includes a specific term corresponding to the frequency index. As illustrated in FIG. 20, the specific term is configured such that RA-RNTI (designated identifier) falls within either the 2-step value range or the third value range.

In this operation example, the specific term is “14×80×f_mu_id”. The UE 100 (controller 120) calculates the value of the specific term based on the variable n indicated by the designation information in addition to the value of the frequency index. When the variable n is 1, the value range of the specific term is 17920 to 35840. Therefore, the RA-RNTI calculated by formula 32 falls within the 2-step value range. When the variable n is 2, the value range of the specific term is 35841 to 53760. Therefore, the RA-RNTI calculated by formula 32 falls within the third value range. When the variable n is 3, the specific term is larger than or equal to 53761.

Here, in a case where the variable n is 3, when the UE 100 (controller 120) selects the auxiliary uplink (SUL) carrier as the uplink carrier, the RA-RNTI calculated by formula E32 may exceed 65522, which is the maximum value that can be allocated as the RNTI, as in the ninth operation example. Therefore, when the variable n is 3, only the normal uplink (NUL) carrier may be selectable as the uplink carrier. In this case, the RA-RNTI falls within a value range of 53761 to 62720.

As described above, formula E32 may include a specific term corresponding to the frequency index. The specific term may be configured such that the RA-RNTI (designated identifier) falls within either the 2-step value range or the third value range. As a result, the value range that can be taken by the RA-RNTI (designated identifier) can be widened, so that the radio resources can be effectively utilized.

The value range of the frequency index may be defined by a variable. The UE 100 (communicator 110) may receive designation information designating a designated index from the base station 200. As a result, the network 10 can flexibly set the value range of the RA-RNTI (designated identifier).

### OTHER EMBODIMENTS

In the operation examples described above, the offset value included in the designated calculation formula may be a value different from the value exemplified in the above-described operation examples. The offset value may be, for example, an odd number multiples of 8960.

In the above-described operation examples, the UE 100 supporting the operation of the 3GPP technical specification prior to Release 16 may calculate the RA-RNTI according to formula A or formula B without using the calculation formulas in the first to tenth operation examples. On the other hand, the UE 100 supporting the operation of the 3GPP technical specification of Release 17 or after may calculate the RA-RNTI according to the calculation formulas in the first to tenth operation examples without using formula A or formula B.

The operation sequence (and the operation flow) in the above-described embodiment may not necessarily be executed in time series according to the order described in the flow diagram or the sequence diagram. For example, the steps in the operation may be performed in an order different from the order described as the flow diagram or the sequence diagram, or may be performed in parallel. In addition, some of the steps in the operation may be removed and additional steps may be added to the process. Furthermore, the operation sequence (and the operation flow) in the above-described embodiment may be performed separately and independently, or may be performed by combining two or more operation sequences (and operation flows). For example, some steps of one operation flow may be added to another operation flow, or some steps of one operation flow may be replaced with some steps of another operation flow.

In the above-described embodiments, a mobile communication system based on the NR is described as an example of the mobile communication system 1. However, the mobile communication system 1 is not limited to this example. The mobile communication system 1 may be a system conforming to a TS of LTE (Long Term Evolution) or another generation system (e.g., a sixth generation) of the 3GPP standard. The base station 200 may be an eNB configured to provide protocol terminations of E-UTRA user plane and control plane toward the UE 100 in LTE. The mobile communication system 1 may be a system conforming to a TS defined in a standard other than the 3GPP standard. The base station 200 may be an IAB (Integrated Access and Backhaul) donor or an IAB node.

A program for causing a computer to execute each process performed by the UE 100 or the base station 200 may be provided. The program may be recorded on a computer readable medium. The program can be installed in the computer by using the computer readable medium. Here, the computer readable medium on which the program is recorded may be a non-transitory recording medium. The non-transitory recording medium is not particularly limited, but may be, for example, a recording medium such as a CD-ROM (Compact Disk Read Only Memory) or a DVD-ROM (Digital Versatile Disc Read Only Memory). Furthermore, a circuit that executes each process to be performed by the UE 100 or the base station 200 may be integrated, and at least a part of the UE 100 or the base station 200 may be configured as a semiconductor integrated circuit (a chipset, a SoC (System On Chip)).

In the above-described embodiment, “transmit (transmit)” may mean to perform a process of at least one layer in a protocol stack used for transmission, or may mean to physically transmit a signal wirelessly or by wire. Alternatively, “transmit” may mean a combination of performing the process of at least one layer and physically transmitting a signal wirelessly or by wire. Similarly, “receive” may mean to perform process of at least one layer in a protocol stack used for reception, or may mean to physically receive a signal wirelessly or by wire. Alternatively, “receive” may mean a combination of performing the process of at least one layer and physically receiving a signal wirelessly or by wire. Similarly, “acquire (obtain/acquire)” may mean to acquire information from stored information, may mean to acquire information from information received from another node, or may mean to acquire the information by generating information. Similarly, the descriptions “based on” and “depending on/in response to” do not mean “based only on” or “depending only on” unless explicitly stated otherwise. The description “based on” means both “based only on” and “based at least in part on”. Similarly, the description “according to” means both “only according to” and “at least partially according to”. Similarly, “include” and “comprise” do not mean to include only the listed items, but mean that the terms may include only the listed items or may include additional items in addition to the listed items. Similarly, in the present disclosure, “or” does not mean exclusive OR but means OR. Moreover, any reference to elements using designations such as “first”, “second”, and the like used in the present disclosure does not generally limit the amount or order of those elements. These designations may be used in the present disclosure as a convenient method to distinguish between two or more elements. Therefore, references to first and second elements do not mean that only two elements can be employed therein or that the first element should precede the second element in any form. In the present disclosure, when articles such as a, an, and the in English are added by translation, these articles include a plurality of articles unless the context clearly indicates otherwise.

Although the present disclosure has been described in accordance with examples, it is understood that the present disclosure is not limited to the examples and structures. The present disclosure also includes various modifications and modifications within an equivalent range. In addition, various combinations and modes, and other combinations and modes including only one element, more elements, or less elements are also within the scope and idea of the present disclosure.

### (Supplementary Notes)

Features related to the above-described embodiment are additionally described.

### (Supplementary Note 1)

A communication apparatus having at least one of a plurality of features defined in a mobile communication system, the communication apparatus comprising:
a communicator; and
a controller, wherein
the communicator is configured to receive, from a base station, a message indicating a correspondence relationship of a combination of one or a plurality of features and a plurality of PRACH time-frequency index sets different for each combination, and
the controller is configured to:
select, based on the correspondence relationship, a PRACH time-frequency index set corresponding to a request feature in which the communication apparatus requests for use from the plurality of PRACH time-frequency index sets; and
calculate a designated identifier from the selected PRACH time-frequency index set according to a designated calculation formula, the designated identifier being a radio network temporary identifier for identifying a random access response from the base station.

### (Supplementary Note 2)

The communication apparatus according to supplementary note 1, wherein
the message is a dedicated message dedicatedly transmitted to the communication apparatus.

### (Supplementary Note 3)

The communication apparatus according to supplementary note 1, wherein the message is a broadcast message transmitted by broadcast.

### (Supplementary Note 4)

The communication apparatus according to any one of supplementary notes 1 to 3, wherein
the designated calculation formula is configured to calculate the designated identifier within a specific value range that is outside a value range of a radio network temporary identifier for identifying a random access response in a 4-step random access type random access procedure.

(Supplementary Note 5)

The communication apparatus according to supplementary note 4, wherein
the specific value range is a value range not included in either a value range of a radio network temporary identifier in the 4-step random access type random access procedure or a value range of a radio network temporary identifier for identifying a random access response in the 2-step random access type random access procedure.

(Supplementary Note 6)

The communication apparatus according to supplementary note 4, wherein
the specific value range is a value range of a radio network temporary identifier for identifying a random access response in a 2-step random access type random access procedure.

### (Supplementary Note 7)

The communication apparatus according to any one of supplementary notes 4 to 6, wherein
the designated formula includes a specific term corresponding to a designated index different from the PRACH time-frequency index set, and
the specific term is configured such that the designated identifier calculated by the designated calculation formula falls within any one of a value range of a radio network temporary identifier for identifying a random access response in a 2-step random access type random access procedure and a value range different from a value range of the radio network temporary identifier in the 4-step random access type random access procedure and a value range of the radio network temporary identifier in the 2-step random access type random access procedure.

### (Supplementary Note 8)

The communication apparatus according to supplementary note 7, wherein
the communicator is configured to receive designation information designating the designated index from the base station.

### (Supplementary Note 9)

The communication apparatus according to any one of supplementary notes 4 to 6, wherein
the PRACH time-frequency index set includes a frequency index indicating a frequency resource position of the random access preamble,
the designated calculation formula includes a specific term corresponding to the frequency index, and
the specific term is configured such that the designated identifier calculated by the designated calculation formula falls within either a value range of a radio network temporary identifier for identifying a random access response in a 2-step random access type random access procedure and a value range different from a value range of the radio network temporary identifier in the 4-step random access type random access procedure and a value range of the radio network temporary identifier in the 2-step random access type random access procedure.

### (Supplementary Note 10)

The communication apparatus according to supplementary note 9, wherein
a value range of the frequency index is defined by a variable, and
the communicator is configured to receive designation information for designating the variable from the base station.

### (Supplementary Note 11)

A base station configured to perform radio communication with a communication apparatus having at least one of a plurality of features defined in a mobile communication system, the base station comprising:
a controller configured to generate a message indicating a correspondence relationship of a combination of one or a plurality of features and a plurality of PRACH time-frequency index sets different for each combination; and
a communicator configured to transmit the message to the communication apparatus.

### (Supplementary Note 12)

A communication method executed by a communication apparatus having at least one of a plurality of features defined in a mobile communication system, the communication method comprising the steps of:
receiving, from a base station, a message indicating a correspondence relationship of a combination of one or a plurality of features and a plurality of PRACH time-frequency index sets different for each combination;
selecting, based on the correspondence relationship, a PRACH time-frequency index set corresponding to a request feature in which the communication apparatus requests for use from the plurality of PRACH time-frequency index sets; and
calculating a designated identifier from the selected PRACH time-frequency index set according to a designated calculation formula, the designated identifier being a radio network temporary identifier for identifying a random access response from the base station.

1. A communication apparatus having at least one of a plurality of features defined in a mobile communication system, the communication apparatus comprising:
a receiver configured to receive, from a base station, a system information block including information indicating a plurality of resources of random access and information indicating correspondence between each of the plurality of resources of the random access and a combination of one or more features; and
a controller configured to select, from the plurality of resources of the random access, a resource of the random access corresponding to the at least one of the plurality of features which the communication apparatus has, on a basis of the information indicating the correspondence, and to calculate a random access-radio network temporary identifier (RA-RNTI) used in a random access procedure on a basis of the selected resource of the random access, wherein
the one or more features includes at least one of a reduced capability (RedCap) feature, a small data feature, a network slicing feature, and a feature for repetition of a message3 (MSG3).

2. The communication apparatus according to claim 1, wherein
the controller is configured to perform the random access procedure by using the selected resource of the random access.

3. A communication method executed by a communication apparatus having at least one of a plurality of features defined in a mobile communication system, the communication method comprising the steps of:
receiving, from a base station, a system information block including information indicating a plurality of resources of random access and information indicating correspondence between each of the plurality of resources of the random access and a combination of one or more features; and
selecting, from the plurality of resources of the random access, a resource of the random access corresponding to the at least one of the plurality of features which the communication apparatus has, on a basis of the information indicating the correspondence, and
calculating a random access-radio network temporary identifier (RA-RNTI) used in a random access procedure on a basis of the selected resource of the random access, wherein
the one or more features includes at least one of a reduced capability (RedCap) feature, a small data feature, a network slicing feature, and a feature for repetition of a message 3 (MSG3).

4. The communication method according to claim 3, comprising the steps of
performing the random access procedure by using the selected resource of the random access.
